(19) United States
(12) Patent Application Publication
(10) Pub. No.: US 2017/0001467 A1
(43) Pub. Date: Jan. 5, 2017

(54) HEATING ERASER FOR REMOVING THERMALLY CHANGEABLE INK

(71) Applicant: Dong-A Pencil Co., Ltd., Seoul (KR)

(72) Inventor: Hak Jae KIM, Daejeon (KR)

(21) Appl. No.: 15/190,723

(22) Filed: Jun. 23, 2016

(30) Foreign Application Priority Data
Jun. 30, 2015 (KR) 10-2015-0093615
Mar. 31, 2016 (KR) 10-2016-0039421

(51) Int. Cl. B43K 29/05; B43K 25/02

(52) U.S. Cl. CPC B43K 29/05; B43K 25/02

(57) ABSTRACT

The heating eraser for removing thermally changeable ink comprises a heating eraser unit that removes or changes a color by instantaneously applying heat at 50 to 65° C. as a color changing temperature range of a phase transition material selectively along a handwriting written or drawn by a writing instrument using the thermally changeable ink containing thermally changeable fine particles of 10 wt % to 70 wt % including a core portion containing the transition material including a phenol-based compound containing an aliphatic functional group having carbon atoms of 6 or more and a shell layer covering the core portion and made of a polymer resin on a substrate.

### CROSS-REFERENCE TO RELATED APPLICATIONS

This application claims priority to and the benefit of Korean Patent Application No. 10-2015-0093615 filed on Jun. 30, 2015 and Korean Patent Application No. 10-2016-0039421 filed on Mar. 31, 2016 in the Korean Intellectual Property Office, the entire contents of which are incorporated herein by reference.

### BACKGROUND OF THE INVENTION

Technical Field

The present invention relates to a heating eraser for removing thermally changeable ink and more particularly, to a heating eraser for removing thermally changeable ink which can change or remove a color by instantaneously applying heat at a selected temperature onto a substrate written by a writing instrument using microcapsulated thermally changeable ink, and simultaneously is simple and increased portable.

The present invention is one of results of the research subject name “development of removable thermoplastic ink using a phase transition phenomenon” which is conducted up to Oct. 12, 2015 to Oct. 11, 2017 by Donga Pencil as the managing department, as Technology Innovation Development Project of the Small Business Technology and Information Promotion Agency under Small Business Administration which is the government support project.

Background Art

Recently, researches on writing instruments using thermally changeable ink using pigments or dyes color-changed by heating and means which removes or changes a color of an image or a handwriting which is written on a paper surface by the thermally changeable ink by heating due to friction have been actively conducted.

However, in the case of the color removing or changing means due to the friction, there are problem in that waste is generally generated during friction by using an elastomer or a plastic foaming body to contaminate the surrounding and simultaneously, it is difficult to permanently use the color removing or changing means due to abrasion.

Further, if an appropriate friction coefficient is not provided by adjusting a material or a level of the an elastomer or the plastic foaming body well, the friction coefficient is very increased, and thus, a paper is damaged or wrinkled, or the surface of the paper becomes rough (is fluffy). Accordingly, re-writing may not be performed on a rubbed place, or spreading occurs in spite of re-writing, and thus, it is inconvenient that a good handwriting may not be formed.

On the contrary, even when the friction coefficient is very small, if the paper is rubbed several times with the load, unevenness is generated on the paper or inconvenience occurs. Meanwhile, in order to solve the problems, researches to ensure an erasable property of the thermally changeable ink by heating have been actively conducted.

However, existing thermally changeable ink is made of a thermally changeable material in which the color is changed at a relatively high temperature. As a result, in order to erase the ink, a heating apparatus having a large volume such as a hair drier or hot water is required, and thus, there is a limit that portability is not satisfied.

Further, only when most erasers are installed on writing instruments using the thermally changeable ink or received in a writing instrument container like the writing instrument using at least the thermally changeable ink, the erasers can be simply carried or conveniently used by a user. However, until now, apparatuses for erasing written notes or images of the writing instrument using the thermally changeable ink having simpleness and portability are not provided.

Further, since it is difficult to control a temperature, there is a risk of stability, and when the image or the handwriting is partially erased, the heat is transferred to an undesired part other than a desired part to change the color, and thus, there is a problem in that a color developing property is not sufficiently maintained.

### DISCLOSURE

### Technical Problem

The present invention has been made in an effort to provide a heating eraser for removing thermally changeable ink having advantages of reducing inconvenience or fatigue due to friction while re-writing a thermally changeable handwriting formed on a paper surface well by changing or removing a color without damaging the paper or generating unevenness on the paper.

Further, a present invention has been made in an effort to provide a heating eraser for removing thermally changeable ink having advantages of changing or removing a color at a desired portion by controlling a temperature, ensuring stability, and smoothly changing or removing the color along an image or a handwriting which is curved or has a large change, while providing a design having simpleness and portability so as to be installed on a writing instrument using thermally changeable ink or received and used in a writing instrument container using at least thermally changeable ink.

### Technical Solution

An exemplary embodiment of the present invention provides a heating eraser for removing thermally changeable ink comprising a heating eraser unit that removes or changes a color by instantaneously applying heat at 50 to 65° C. as a color changing temperature range of a phase transition material selectively along the handwriting written or drawn by a writing instrument using the thermally changeable ink containing thermally changeable fine particles of 10 wt % to 70 wt % including a core portion containing the transition material including a phenol-based compound containing an aliphatic functional group having carbon atoms of 6 or more and a shell layer covering the core portion and made of a polymer resin on a substrate, in which the heating eraser unit is integrally coupled with the writing instrument, separated from the writing instrument, has the writing instrument form, or detachably coupled with at least a part of the writing instrument.

The heating eraser for removing thermally changeable ink may further include a heat supply unit supplying hot air or heat by facing the substrate, a heat generating unit disposed adjacently to the heat supply unit for supplying the heat to the heat supply unit to instantaneously generate heat at 50 to 65° C., a temperature control unit controlling the temperature of the heat generated from the heat generating unit to 50 to 65° C., and a cooling unit cooling the heat generated from the heat generating unit under a control of the temperature control unit, in which the heat supply unit has at least one form of a slim bar form, a rob form, a detachable form to the outside of the writing instrument using the thermally changeable ink, and a writing instrument form.

The temperature control unit may communicate with an external-air ventilation path corresponding to the shape of the heat supply unit to supply cooling air to the heat supply unit and a cooling fan disposed vertically to the external-air ventilation path.

The heat generating unit may include a heating resistor disposed in a zigzag shape with a plane when the heat supply unit is formed of a planar elastic member and a linear heating resistor connected with the power supply unit to heat the heating resistor.

The heat generating unit may include a heating resistor disposed in a disk shape or a coil shape when the heat supply unit has a pipe shape or a cone shape and a linear heating resistor connected with the power supply unit to heat the heating resistor.

The heat supply unit may be a thermally stable heat-resistant pad. The writing instrument using thermally changeable ink may be at least one of ballpoint pens, fountain pens, sign pens, and magic markers.

The heating resistor may be selected from a heat wire of a small heating wire heater, an induction heater, a PTC thermistor of a semiconductor heating element, ceramic PTC or polymeric PTC, a conductive polymer, a heating element using a carbon resistor, and the like.

The heating resistor may be connected with a stable circuit interrupting overheating.

The substrate may be one of labels, packages, printed materials, signboards, and notices which are re-writable by changing or removing at least partially the color of the handwriting written by the writing instrument using the thermally changeable ink.

### Advantageous Effects

According to an exemplary embodiment of the present invention, it is possible to reduce inconvenience due to friction, a dirty problem by spreading the ink, or user's fatigue in order to erase a handwriting or an image ion a paper surface while re-writing a thermally changeable handwriting formed on the paper surface well by changing or removing the color without damaging the paper or generating unevenness on the paper.

Further, it is possible to change or remove a color at a desired portion by controlling a temperature, ensure stability, and smoothly change or remove the color along an image or a handwriting which is curved or has a large change, while providing a design having simpleness and portability so as to be installed on a writing instrument using thermally changeable ink or received and used in a writing instrument container using at least thermally changeable ink.

### DESCRIPTION OF THE DRAWINGS

FIG. 1 is a schematic explanatory diagram of a heating eraser for removing thermally changeable ink according to an exemplary embodiment of the present invention.

FIG. 2 is a perspective view of a heating eraser for removing thermally changeable ink according to a first exemplary embodiment of the present invention.

FIG. 3 is a side view of FIG. 2 viewed from the bottom.

FIG. 4 is an exploded perspective view of a heating eraser for removing thermally changeable ink according to a second exemplary embodiment of the present invention.

FIG. 5 is a perspective view of a heating eraser for removing thermally changeable ink having an enlarged cross-sectional view of a heating eraser for removing thermally changeable ink according to a third exemplary embodiment of the present invention.

FIG. 6 is a partially exploded perspective view of a heating eraser for removing thermally changeable ink according to a fourth exemplary embodiment of the present invention.

### MODE FOR INVENTION

Hereinafter, exemplary embodiments of the present invention will be described in detail with reference to the accompanying drawings. The present invention is described with reference to the exemplary embodiments illustrated in the drawings, but is just described as one exemplary embodiment and not limited thereto.

In the description below, members, portions, and configurations having the same function designate like reference numerals and the description thereof will be omitted.

Further, in this specification, thermally changeable ink may be applied to all of writing instruments such as ballpoint pens, color pencils, or hair pencils.

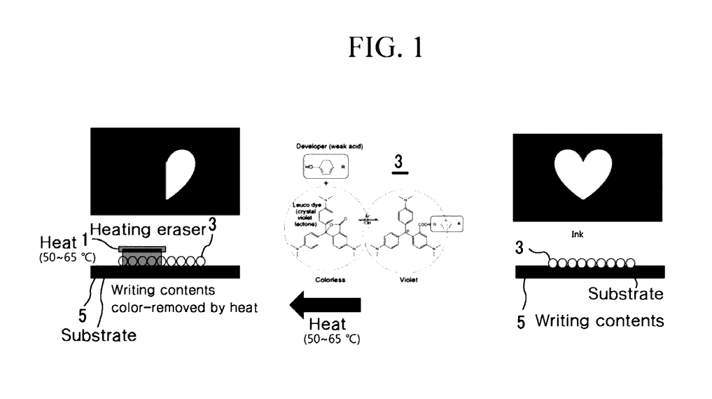

First, a concept of a heating eraser for removing thermally changeable ink according to an exemplary embodiment of the present invention will be described with reference to FIG. 1.

In the heating eraser for removing the thermally changeable ink according to the exemplary embodiment of the present invention, a heating eraser unit 1 is configured to remove or change a color by applying heat of 50 to 65° C. to a handwriting 5 written or drawn on a substrate 3 by the thermally changeable ink.

To this end, the heating eraser unit 1 includes a phase transition material verifying unit 1a that verifies whether the handwriting 5 includes a phase transition material to be described below in detail, a heat supply unit 1b made of an elastic material which selectively applies the heat while being adapted along the handwriting made of the phase transition material verified by the phase transition material verifying unit 1a, a temperature control unit 1c that controls the temperature of the heat supply unit 1b to 50 to 65° C. which is a color changing temperature range of the phase transition material, and a cooling unit 1e which cools the temperature when a heat generating unit 1d generating the heat supplied by the heat supply unit 1b is heated to a predetermined temperature or more under the control of the temperature control unit 1c.

As a result, the heating eraser unit 1 may allow the heat supply unit 1b to operate only along the handwriting including the phase transition material by the phase transition material verifying unit 1a.

Further, the temperature control unit 1c may include a temperature control circuit which controls the heat generating unit 1d and the cooling unit 1e to maintain the temperature of the heat supply unit 1b to 50 to 65° C. at which phase transition may occur to block power supply of a power supply unit to be described below at a predetermined temperature or more even through the heat generating unit 1d operates and controls the temperature to be a predetermined temperature by operating the cooling unit 1e.

Stability may be provided from a risk such as fire by the temperature control unit 1c regardless of a kind of substrate 3 and a color at an undesired portion may be prevented from being removed or changed by the heat supply unit 1b, and thus, re-writing is possible after removing or changing the color.

The substrate 3 may be a multi-using price tags, a multi-using shop paper board, a multi-using memo pad, a memo pad for managing a schedule, and a multi-using easel pad, or may be a state board substitute or an eco-friendly board. The substrate 3 may be a magnetic writing board for children or a scribble board for children, a sketch board, or the like, may be a semi-transparent thin paper used when copying figures or design drawings, or may be a scenario board constituted by scenarios of video designs such as movies, dramas, or animations as drawings.

Meanwhile, the thermally changeable ink 5 includes thermally changeable minute particles having a core portion including a phase transition material containing a phenol-based compound containing an aliphatic functional group having carbon atoms of 6 or more and dyes and a shell layer made of a polymer resin. The thermally changeable ink 5 is constituted to easily maintain the color developing property and the color removing property by uniformly controlling the temperature range at which the thermal color changing is performed by the phase transition material.

Meanwhile, the phase transition material may be rapidly removed by a simple removing method while maintaining an excellent color developing property by adjusting the thermal color changing of the dyes at a color changing temperature range defined by Formula 1 of 50° C. or more.

In detail, the thermally changeable fine particles has a large color changing temperature range defined by the following Formula 1 of 50° C. or more, and a phase transition section in which a solid phase and a liquid phase of the phase transition material coexist is widened and thus, it is easy to maintain a color developing or removing state after changing the color.

[Formula 1]

Color changing temperature range (ΔT)=absolute value of difference between melting point and crystallization temperature of material

The melting temperature Tm is a temperature when a state is changed from solid to liquid, and particularly, means the lowest temperature at which the phase transition material may exist in a completely liquid state. Further, the crystallization temperature Tc means a temperature at which the crystallization occurs or a heat treatment temperature required for crystallization, and particularly, means the highest temperature at which the phase transition material may exist in a completely solid state.

The phase transition material may have a crystallization temperature of −20° C. to 0° C. or −10° C. to 5° C. Further, the phase transition material may have a melting point of 30° C. or more, 40° C. or more, or 50° C. or more.

The content of the phase transition material included in the thermal changeable fine particles may be 10 wt % to 70 wt % or 20 wt % to 70 wt % based on a weight of the thermal changeable fine particles. Accordingly, in the thermal changeable fine particles, a phase transition section in which a solid phase and a liquid phase of the phase transition material coexist is widened and thus, it is easy to maintain a color developing or removing state after changing the color.

The phase transition material has a chemical structure which may simultaneously serve as a developer used for developing the exiting dyes and is constituted so as not to separately add the developer to the thermal changeable fine particles.

Even though the phase transition material contacts a chemically active material such as an acidic substance, a basic substance, and peroxide or other solvent components by the shell layer made of the polymer resin, deterioration of the function may be prevented and stability of heat resistance may be ensured.

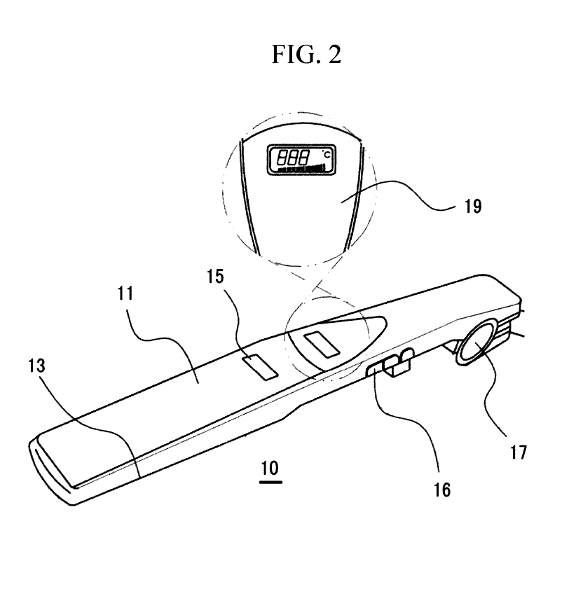

Hereinafter, heating erasers for removing thermal changeable ink according to exemplary embodiments of the present invention will be described in detail with reference to FIGS. 2 to 6.

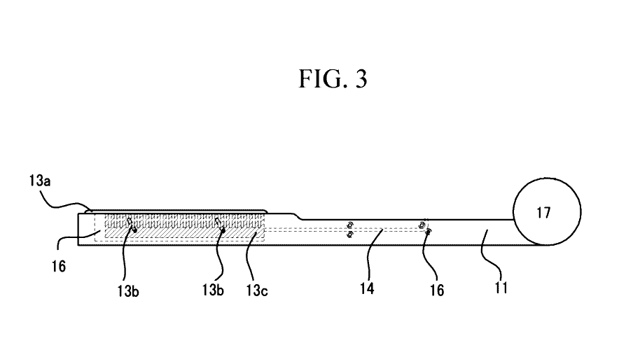

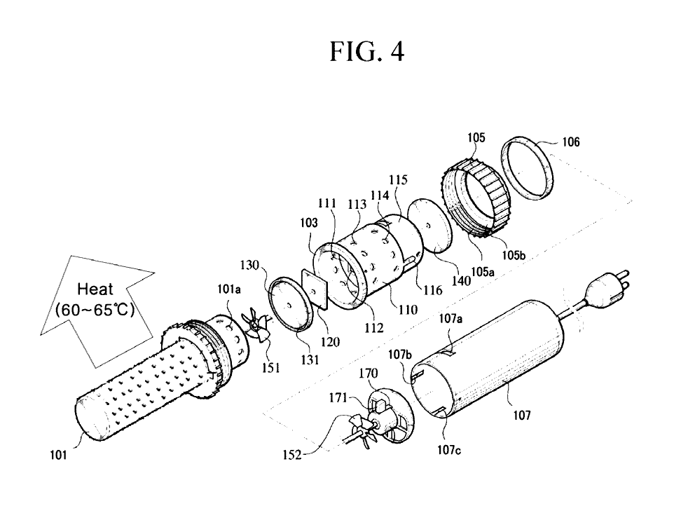

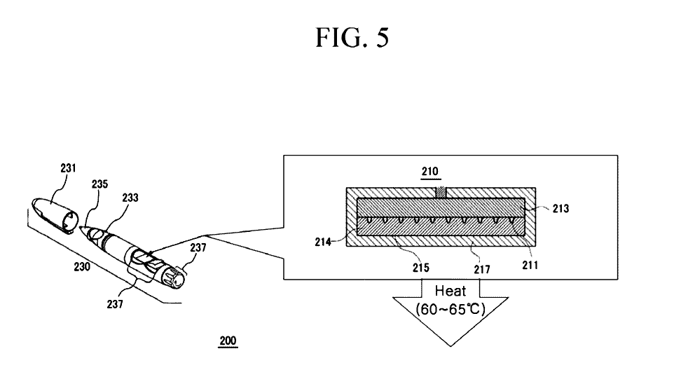

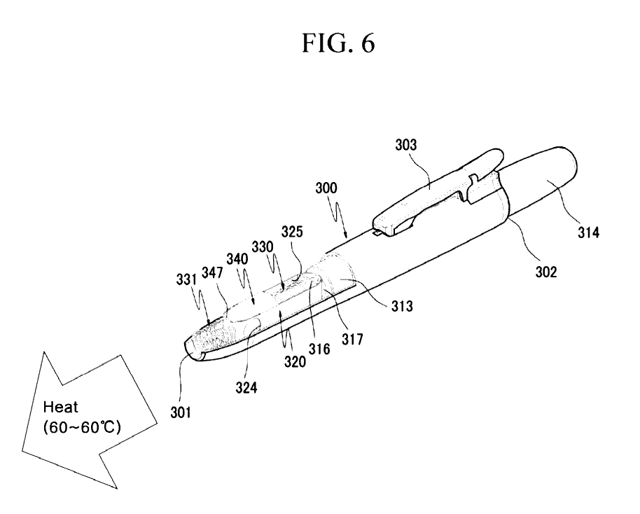

FIG. 2 is a perspective view of a heating eraser for removing thermally changeable ink according to a first exemplary embodiment of the present invention, FIG. 3 is a side view of FIG. 2 viewed from the bottom, FIG. 4 is an exploded perspective view of a heating eraser for removing thermally changeable ink according to a second exemplary embodiment of the present invention, FIG. 5 is a perspective view of a heating eraser for removing thermally changeable ink having an enlarged cross-sectional view of a heating eraser for removing thermally changeable ink according to a third exemplary embodiment of the present invention, and FIG. 6 is a partially exploded perspective view of a heating eraser for removing thermally changeable ink according to a fourth exemplary embodiment of the present invention.

As illustrated in FIGS. 2 and 3, a heating eraser 10 for removing thermally changeable ink according to a first exemplary embodiment of the present invention may include a main body 11 having a slim bar shape made of a synthetic resin material, a heat supply unit 13 made of a planar elastic member attached to at least a part except for a grip portion of the bottom of the main body 11, a heat generating unit 14 instantaneously generating heat at a predetermined temperature so that the heat supply unit 13 supplies the heat to the substrate 3, a temperature control unit 15 uniformly controlling the temperature of the heat supply unit 13, and a power supply unit 17 supplying power to the heat generating unit 13.

The power supply unit 17 is turned on or off by a switch unit 16 determining whether the power is supplied and the temperature controlled by the temperature control unit 15 is visibly displayed through a display unit 19 to enhance stability.

The heat supply unit 13 is constituted by a thermally stable heat-resistant pad 13a, and the thermally stable heat-resistant pad 13a may be made of rubber and the like. When the heat supply unit 13 has a slim bar shape, the thermally stable heat-resistant pad 13a is disposed to be parallel with the heat generating unit 14 therebelow to have a planar shape in order to have a color changing temperature range of 60 to 65° C. which is uniform at the entire area.

The heat generating unit 14 includes a heating resistor 14a which is disposed in parallel with a plane in a zigzag shape with a predetermined interval, an instantaneous heating unit 14b having a pin shape so that a surface area is increased to instantaneously heat the heating resistor 14a to the color changing temperature range, and a heating resistor 14c of which one end is connected to the power supply unit 17 and the other end is connected to the instantaneous heating unit 14b so as to apply the power to the instantaneous heating unit 14b from the power supply unit 17.

A safe circuit for preventing overheating by blocking the connection with the heating resistor 14c may be further connected to the heating resistor 14a.

The heat generating unit 14 is arranged in parallel in a length direction of the main body 11, and the instantaneous heating unit 14b has a plurality of pin shapes to increase the surface area and may be instantaneously heated. A ventilation unit 18 as a cooling means around the instantaneous heating unit 14b cools the instantaneous heating unit 14b by using external air under the control of the temperature control unit 15 to prevent the instantaneous heating unit 14b from being heated to a predetermined temperature or more.

That is, when the instantaneous heating unit 14b is heated at the predetermined temperature or more under the temperature control of the temperature control unit 15, the power of the power supply unit 17 is blocked by the switch unit 16 to save energy. The instantaneous heating unit 14b may be rapidly controlled to be a predetermined temperature or less by air flowing in the ventilation unit 18 which is disposed to face the instantaneous heating unit 14b.

As such, the heating eraser 10 for removing the thermally changeable ink according to the first exemplary embodiment of the present invention has a heating eraser unit having a slim bar shape to be received like a writing portion using thermally changeable ink in a writing instrument container, and thus, is easily portable.

Further, the thermally stable heat-resistant pad 13a is detachably installed in the main body 11 and only the thermally stable heat-resistant pad 13a may be interchangeably designed.

The power supply unit 17 may be a general battery, but may freely adjust application voltage to the heating resistor 14a by stacking button type batteries in series.

The heating resistor 14a may use a heat wire of a small heating wire heater, an induction heater, a PTC thermistor of a semiconductor heating element, ceramic PTC or polymeric PTC, a conductive polymer, a heating element using a carbon resistor, and the like.

The heating eraser 10 for removing the thermally changeable ink according to the first exemplary embodiment of the present invention is constituted to remove the handwriting only by contacting the thermally stable heat-resistant pad 13a and the handwriting 3 of the writing instrument using the thermally changeable ink by embedding the heating resistor 14a in the main body 11 made of an insulating material to heat the thermally stable heat-resistant pad 13a itself from the inside.

The thermally stable heat-resistant pad 13a is made of an elastic material to be smoothly movable along the handwriting 3 and the heat of the thermally stable heat-resistant pad 13a is prevented from being transferred outside by the main body 11 to prevent the color of a portion other than the handwriting at the desired portion from being changed or removed.

Hereinafter, a heating eraser 100 for removing thermally changeable ink according to a second exemplary embodiment of the present invention that has a rod shape separately from the writing instrument using the thermally changeable ink will be described with reference to FIG. 4.

As illustrated in FIG. 4, the heating eraser 100 for removing the thermally changeable ink according to the second exemplary embodiment of the present invention includes a heat supply unit 101, a heat generating unit 103, a temperature control unit 170, and cooling units 151 and 152 like the heating eraser 10 for removing the thermally changeable ink according to the first exemplary embodiment of the present invention. However, a heating eraser unit of the heating eraser 100 for removing the thermally changeable ink according to the second exemplary embodiment of the present invention has a rod shape, and thus, there is a difference in each structure and arrangement therebetween, and the difference will be described in detail.

In the heating eraser 100 for removing the thermally changeable ink according to the second exemplary embodiment of the present invention, the heat supply unit 101 is formed of a thermally stable heat-resistant pad having a rod shape and a plurality of hot-air holes 101a is perforated in a hollow shape.

Accordingly, when the heat supply unit 101 faces the handwriting by the writing instrument using the thermally changeable ink, the color may be smoothly removed or changed along the handwriting. Particularly, it is very advantageous to remove or change the color in a large area.

The heat generating unit 103 has a pipe shape to be connected to the heat supply unit 101 in a length direction. In the heat generating unit 103, a pipe-shaped heating body 110 having inlets 113 and 114 in which external air flow are formed and made of an insulating material so as to prevent the heat generated in a thermoelectric module 120 from being discharged to the outside, a thermoelectric module fixing plate 111 fixing an instantaneous heating unit 120 to the inside of the heating body 110 with a installation hole 112, a thermoelectric module configuring the instantaneous heating unit 120, and a first heat conductive plate 130 and a second conductive plate 140 as heating resistors heated by the instantaneous heating unit 120 at a predetermined temperature are installed at predetermined intervals in a coaxial direction.

Meanwhile, a first fan 151 and a second fan 152 which are cooling units connected to a rotational shaft are installed to face the first heat conductive plate 130 and the second conductive plate 140 so as to prevent the first heat conductive plate 130 and the second conductive plate 140 from being heated at a predetermined temperature or more, respectively, to be operated under the control of the temperature control unit 170.

The heat generating unit 103 constituted above is embedded in an external case 107 having connection grooves 107a and 107b, and one end of the external case 107 may be connected to a connection protrusion formed on an outer periphery below the heat supply unit 101 to be coupled with a connection unit 105 through a sealing ring 106.

According to the configuration, the thermoelectric module 120 as the instantaneous heating unit is coupled with the module installation hole 112 of the module fixing plate 111 provided in the heating body 110 to rapidly and instantaneously supply the generated heat or cooling air toward the heat supply unit 101 through the first and second fans. Thus, the temperature may be instantaneously controlled by a simple configuration, and the heating eraser has the rod shape to be receivable or portable in the writing instrument container.

Hereinafter, a heating eraser 200 for removing thermally changeable ink according to a third exemplary embodiment of the present invention which is detachably coupled with at least an outside of a writing instrument using the thermally changeable ink will be described with reference to FIG. 5.

As illustrated in FIG. 5, a heating eraser unit 210 of the heating eraser 200 for removing the thermally changeable ink according to the third exemplary embodiment of the present invention includes a heat supply unit 211, a heat generating unit 211, a power supply unit 213, a heat supply unit 214, a temperature control unit 215, and a cooling unit 217, like the heating eraser 10 for removing the thermally changeable ink according to the first exemplary embodiment of the present invention. However, the heating eraser unit 210 of the heating eraser 200 for removing the thermally changeable ink according to the third exemplary embodiment of the present invention has a cardboard shape, and thus, there is a difference in each structure and arrangement therebetween, and the difference will be described in detail.

As illustrated in FIG. 5, in the heating eraser 200 for removing the thermally changeable ink according to the third exemplary embodiment of the present invention, the heating eraser unit 210 is detachably installed to at least a part of a writing instrument 230 using the thermally changeable ink, preferably, the outer periphery thereof.

The writing instrument 230 using the thermally changeable ink includes a cap 230 which is detachable from a main body 233 for protecting a point portion 235 to be described below, the main body 233 with the thermally changeable ink, a point portion 235 used for writing on a substrate 5 by extracting the thermally changeable ink from the main body 233, a switch 237 disposed at the rear side of the main body 233 so as to control the length of the point portion 235, and a receiving unit 239 receiving the heating eraser unit 210 from the outside of the main body 233.

The receiving unit 239 is formed with a groove and may further incudes a clip or a band 239a for supporting the heating eraser unit 210 to be detachable.

In the heating eraser 200 for removing the thermally changeable ink according to the third exemplary embodiment of the present invention, the heat generating unit 211 of the heating eraser unit 210 may be embedded in the heat supply unit 214 made of the elastic material and having the cardboard shape at a predetermined interval, and the power supply unit 213 may be provided in a cardboard shape to face the heat supply unit 214. When the temperature of the heat supply unit 214 is the predetermined temperature or more, a shell-shaped cooling unit 217 may be constituted to be disposed to cover the heat supply unit 214 under the control of the temperature control unit 215 installed closely to the heat supply unit 214 and instantaneously cool the heat supply unit 214 by dispersing the air flowing through an external ventilation path 217a.

Accordingly, the heating eraser unit 210 is provided in the slim board shape to be separated from the writing instrument 230 using the thermally changeable ink and faces the surface adaptationally along the handwriting to change or remove the color without damaging the substrate or spreading the ink.

Finally, a heating eraser 300 for removing thermally changeable ink according to a fourth exemplary embodiment of the present invention that has an appearance of a writing instrument will be described with reference to FIG. 6.

As illustrated in FIG. 6, the heating eraser 300 for removing the thermally changeable ink according to the fourth exemplary embodiment of the present invention includes a heat generating unit 330, a power supply unit 314, a heat supply unit 331, a temperature control unit 325, and a cooling unit 313, like the heating eraser 10 for removing the thermally changeable ink according to the first exemplary embodiment of the present invention. However, the heating eraser 300 for removing the thermally changeable ink according to the fourth exemplary embodiment of the present invention has an appearance of a writing instrument, and thus, there is a difference in each structure and arrangement therebetween, and the difference will be described in detail.

As illustrated in FIG. 6, the heating eraser 300 for removing the thermally changeable ink according to the fourth exemplary embodiment of the present invention may includes a main body 302 having an appearance of a writing instrument having an opening 301 at the front end, made of an insulating material, and having a hollow shape, a clip portion 303 disposed at an outer periphery of the main body 302 to be inserted or hooked to notes or clothes, and a power supply unit 314 disposed at the rear end of the main body 302 to supply or interrupt the power in a push-type button shape.

The heat generating unit 130 may have a heating resistor disposed in a coil form in the main body 302 and a heating resistor connecting the heating resistor with the power supply unit 314.

The temperature control unit 325 is disposed to be adjacent to the heat generating unit 130, and when the heat generating unit 130 is at a predetermined temperature or more under a control of the temperature control unit 325, a cooling means 313 having a ventilator form may operate.

The cooling means 313 may communicate with a ventilation path 316 installed to instantaneously cool the heat generating unit 130 by flowing external air from the opening 301 through an air inlet 317.

The heat generated from the heat generating unit 130 is ventilated by the ventilator 313 to be transferred to the heat supply unit 131 having a spring shape through a heating path 324 extended in a length direction of the heat generating unit 130.

Only when the heat supply unit 131 is gently pressed along the handwriting by the writing instrument 3 using the thermally changeable ink in the spring shape made of the elastic material, the color of the handwriting may be changed or removed.

In the heating eraser 300 for removing the thermally changeable ink according to the fourth exemplary embodiment of the present invention, the heat generating unit 330 and the cooling unit 320 commonly use the ventilator 113 according to the control of the temperature control unit 325 to provide a small and portable configuration.

Meanwhile, in the heat generating unit 330, upper, lower, left and right sides are insulated from each other by the insulation unit 340, and thus, even though the heat generating unit 330 is used with a hand, the heat generating unit 330 may be safely used from burn and the like.

### DESCRIPTION OF SYMBOLS

Heat supply unit: 13, 101, 214, 331

Heat generating unit: 14, 103, 211, 330

Temperature control unit: 15, 170, 215, 325

Cooling unit: 18, 151, 152, 217, 320

What is claimed is:

1. A heating eraser for removing thermally changeable ink comprising a heating eraser unit that removes or changes a color by instantaneously applying heat at 50 to 65° C. as a color changing temperature range of a phase transition material selectively along a handwriting written or drawn by a writing instrument using the thermally changeable ink containing thermally changeable fine particles of 10 wt % to 70 wt % including a core portion containing the transition material including a phenol-based compound containing an aliphatic functional group having carbon atoms of 6 or more and a shell layer covering the core portion and made of a polymer resin on a substrate, wherein the heating eraser unit is integrally coupled with the writing instrument, separated from the writing instrument, has the writing instrument form, or detachably coupled with at least a part of the writing instrument.

2. The heating eraser for removing thermally changeable ink of claim 1, further comprising:
a heat supply unit supplying hot air or heat by facing the substrate, a heat generating unit disposed adjacently to the heat supply unit for supplying the heat to the heat supply unit to instantaneously generate heat at 50 to 65° C., a temperature control unit controlling the temperature of the heat generated from the heat generating unit to 50 to 65° C., and a cooling unit cooling the heat generated from the heat generating unit under a control of the temperature control unit, wherein the heat supply unit has at least one form of a slim bar form, a rob form, a detachable form to the outside of the writing instrument using the thermally changeable ink, and a writing instrument form.

3. The heating eraser for removing thermally changeable ink of claim 2, wherein:
the temperature control unit communicates with an external-air ventilation path corresponding to the shape of the heat supply unit to supply cooling air to the heat supply unit and a cooling fan disposed vertically to the external-air ventilation path.

4. The heating eraser for removing thermally changeable ink of claim 2, wherein:
the heat generating unit includes a heating resistor disposed in a zigzag shape with a plane when the heat supply unit is formed of a planar elastic member and a linear heating resistor connected with the power supply unit to heat the heating resistor.

5. The heating eraser for removing thermally changeable ink of claim 4, wherein:
the heat generating unit includes a heating resistor disposed in a disk shape or a coil shape when the heat supply unit has a pipe shape or a cone shape and a linear heating resistor connected with the power supply unit to heat the heating resistor.

6. The heating eraser for removing thermally changeable ink of claim 4, wherein:
the heat supply unit is a thermally stable heat-resistant pad.

7. The heating eraser for removing thermally changeable ink of claim 4, wherein:
the heating resistor is selected from a heat wire of a small heating wire heater, an induction heater, a PTC thermistor of a semiconductor heating element, ceramic PTC or polymeric PTC, a conductive polymer, a heating element using a carbon resistor, and the like.

8. The heating eraser for removing thermally changeable ink of claim 4, wherein:
the heating resistor is connected with a stable circuit interrupting overheating.

9. The heating eraser for removing thermally changeable ink of claim 2, wherein:
the writing instrument using thermally changeable ink is at least one of ballpoint pens, fountain pens, sign pens, and magic markers.

10. The heating eraser for removing thermally changeable ink of claim 2, wherein:
the substrate is one of labels, packages, printed materials, signboards, and notices which are re-writable by changing or removing at least partially the color of the handwriting written by the writing instrument using the thermally changeable ink.
